(19) United States
(12) Patent Application Publication
(10) Pub. No.: US 2014/0369036 A1
(43) Pub. Date: Dec. 18, 2014

(54) LED LIGHT AND FILAMENT THEREOF

(71) Applicant: SHENZHEN RUNLITE TECHNOLOGY CO.,LTD., Shenzhen City (CN)

(72) Inventor: Yunlong FENG, Shenzhen City (CN)

(73) Assignee: SHENZHEN RUNLITE TECHNOLOGY CO.,LTD., Shenzhen City (CN)

(21) Appl. No.: 14/040,753

(22) Filed: Sep. 30, 2013

(30) Foreign Application Priority Data
Jun. 17, 2013 (CN) 201310239213.5

(51) Int. Cl. F21K 99/00

(52) U.S. Cl. CPC F21K 9/17; F21K 9/50
USPC 362/223; 362/217.14

(57) ABSTRACT

The invention discloses a LED lamp and filament thereof. The LED filament includes a substrate, a light emitting unit secured onto at least one side surface of the substrate, and a package adhesive layer surrounded on the periphery of the light emitting unit; the substrate is configured to be of an elongated bar construction; the light emitting unit comprises a plurality of blue light chips and red light chips regularly distributed on the substrate and sequentially connected to one another in series. For the LED filament of the invention, as the light emitting unit composed of blue and red light chips is disposed on the substrate, the LED filament has high color rendering and large light radiation angle.

### FIELD OF THE INVENTION

The present invention relates to LED lighting technology and more particularly, relates to a LED light and filament thereof.

### BACKGROUND OF THE INVENTION

A filament of a traditional lighting lamp is directly constructed of illuminant metal filament such as tungsten filament. This kind of filament suffers from drawbacks such as short lifetime and heavy power consumption. Furthermore, it can only generate yellow light and is thus poor in color rendering.

With the development of science and technology, LED light has gradually replaced of traditional lighting lamps. A conventional LED light is provided with a light emitting module, and includes a bracket of square or circle type, a LED chip disposed at one side of the bracket, and a lens covered on a surface of the LED chip. For a conventional LED light, fluorescent powder is generally provided on a blue light LED chip for creating white light. Led light has poor color rendering in entirety. In addition, a prior art bracket is formed of conductive metal such as copper and alumina into which PPA material is plastic molded and accordingly, it is not light transmissible. Light can be transmitted at a surface of 180 degree only at one side on which the LED chip is disposed. The entire light transmission angle is small. Even optically processed by the lens for a second time, the light transmission angle is still not greater than 165 degree. Moreover, PPA material is subject to yellowing and changes in color, thereby having influence on overall quality of the LED light. Further, a conventional LED light emitting module is mostly packaged by flat adhesive dispensing technique with low efficiency and yield. In addition, it causes high cost.

### SUMMARY OF THE INVENTION

The technical problem to be solved by the present invention is to provide a LED filament with high color rendering property.

The technical problem to be further solved by the present invention is to provide a LED light with high color rendering property.

To solve the above problems, the present invention offers a LED filament including a substrate, a light emitting unit secured onto at least one side surface of the substrate, and a package adhesive layer surrounded on the periphery of the light emitting unit. The substrate is configured to be of an elongated bar construction. The light emitting unit includes a plurality of blue light chips and red light chips regularly distributed on the substrate and sequentially connected to one another in series.

Preferably, one red light chip is disposed between at least every two said blue light chips.

Preferably, the substrate is 5.00 mm-200.00 mm long, 0.50-10.00 mm wide, and 0.10 mm-5.00 mm high.

Preferably, two side surfaces of the substrate are provided with the light emitting unit.

Preferably, the package adhesive layer is circular in cross section and the diameter is 1.00 mm-10.00 mm.

Preferably, the package adhesive layer is made of transparent colloid material containing fluorescent powder.

Preferably, the substrate is configured to be transparent.

Preferably, the package adhesive layer is formed by molding process.

Preferably, the blue and red light chips are connected to one another in series by a metal conductive cable and, the two ends of the substrates are provided with electrode pins connected respectively to the two ends of the metal conductive cable.

Correspondingly, the present invention also provides a LED light including a LED filament as described above.

The present invention has advantages. For example, light color rendering is effectively improved for LED filament due to construction of elongated bar-shaped substrate forming the main body of the LED filament and due to placement of the light emitting composed of blue and red light chips on at least one side of the substrate. In addition, as the substrate is configured to be transparent, light emitting angle and efficiency of the LED filament is also significantly improved. Moreover, the package adhesive layer is formed by molding process leading to simple process, high productivity and yield. Furthermore, production cost is low.

### BRIEF DESCRIPTION OF THE DRAWINGS

FIG. 1 is a front structural view of a LED filament of the present invention;

FIG. 2 is an enlarged view of portion A of FIG. 1;

FIG. 3 illustrates a left side view of the LED filament of a first embodiment of the invention with a package adhesive layer being removed;

FIG. 4 shows an enlarged view of portion B of FIG. 3;

FIG. 5 schematically shows light emitting status of the LED filament according to a first embodiment of the invention;

FIG. 6 illustrates a left side view of the LED filament of a second embodiment of the invention with a package adhesive layer being removed;

FIG. 7 is an enlarged view of portion C of FIG. 6;

FIG. 8 schematically shows light emitting status of the LED filament according to a second embodiment of the invention; and

FIG. 9 denotes light distribution curve of the LED filament of the present invention.

### DETAILED DESCRIPTION OF THE INVENTION

It is noted that, in case no interference is resulted in, the embodiments and features contained therein may be combined with each other. The present invention is described in greater detail in conjunction with the accompanying drawings and embodiments.

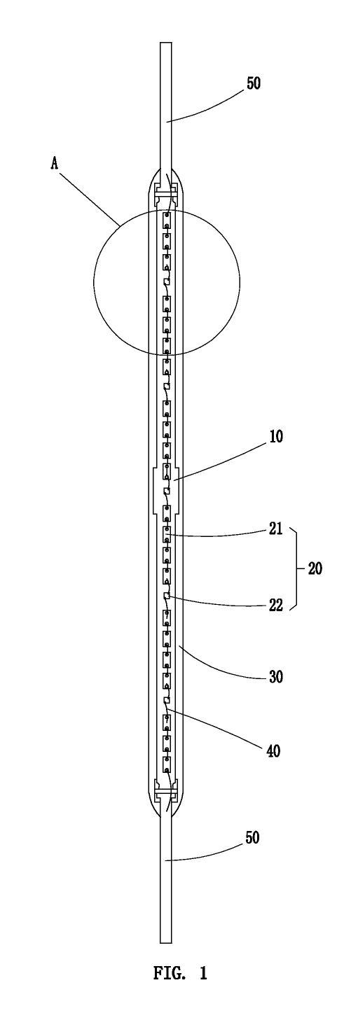

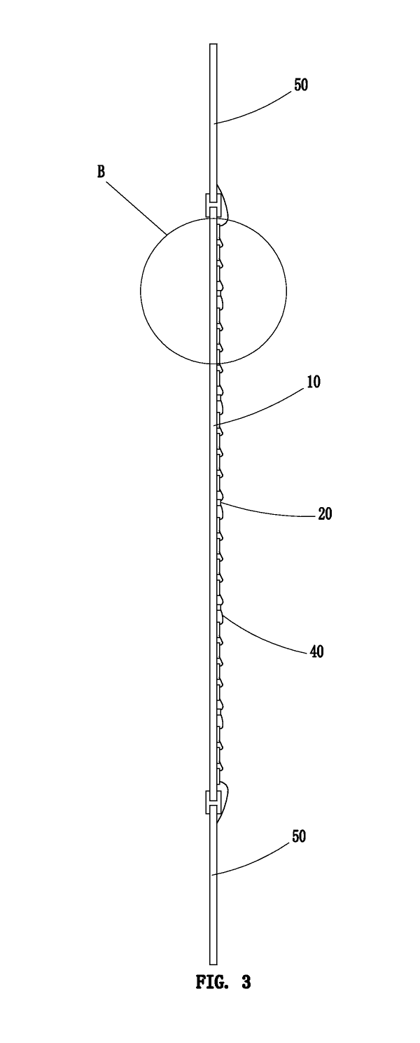

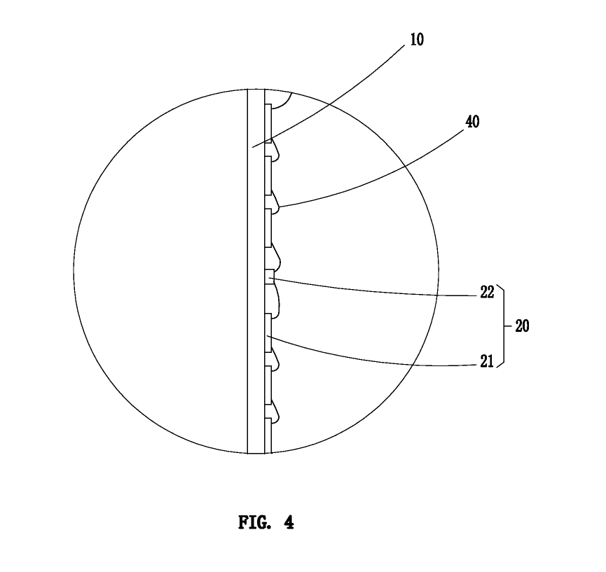

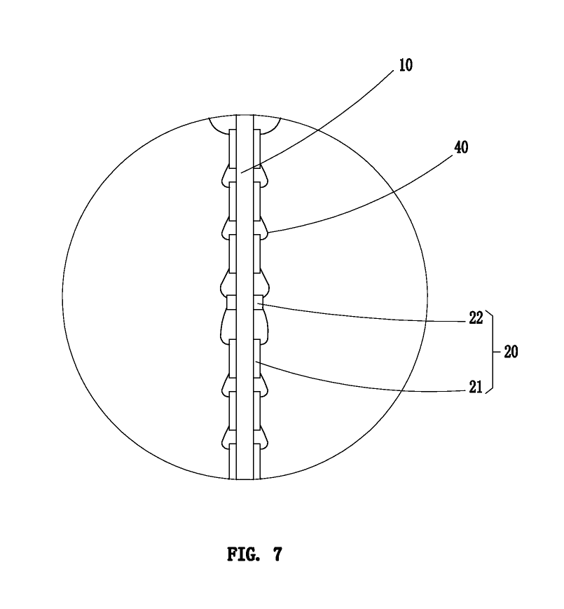

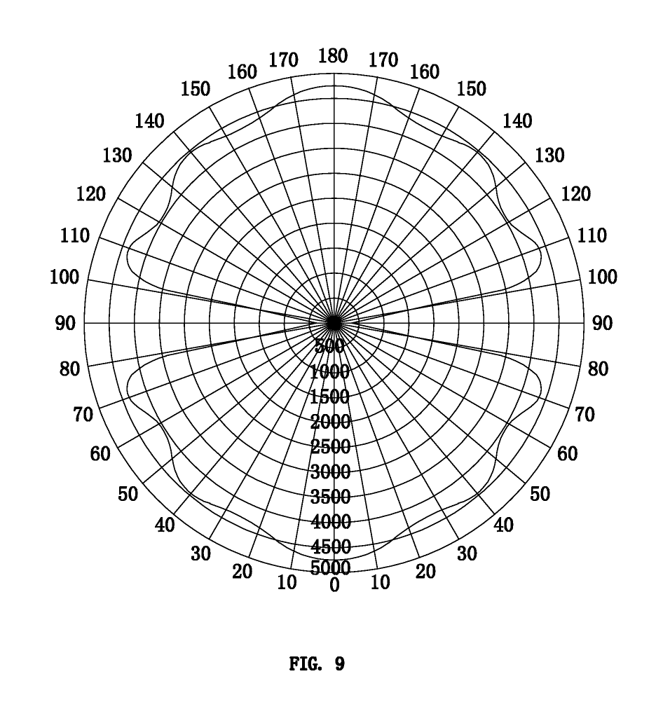

As shown in FIG. 1-9, the invention provides a LED filament including a substrate 10, a light emitting unit 20 and a package adhesive layer 30.

The substrate 10 is set to be of an elongated bar-shaped construction to constitute a main body of the LED filament. In present embodiment, the length of the substrate ranges from 5.00 mm to 200.00 mm, the width thereof ranges from 0.50 to 10.00 mm, and height thereof ranges from 0.10 mm to 5.00 mm.

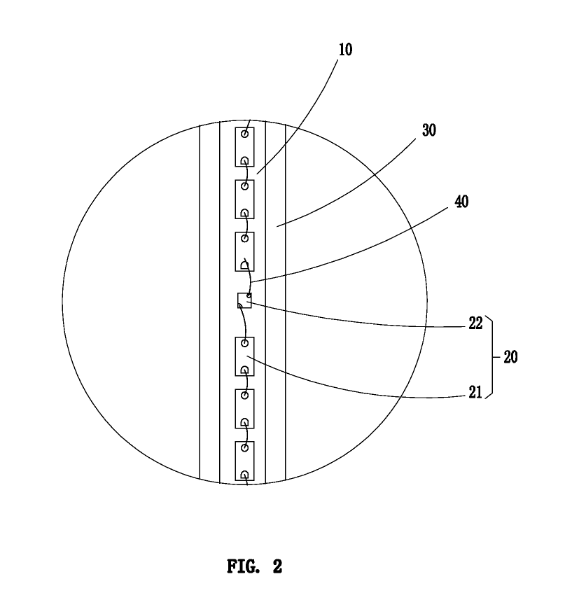

With reference to FIGS. 2, 4 and 7, the light emitting unit 20 is fastened onto at least one side surface of the substrate 10, and includes plural regularly distributed blue light chips 21 and red light chips 22. The blue light chips 21 and red light chips 22 are sequentially connected to one another in series by a metal conductive cable 40. Two ends of the substrates 10 are provided with electrode pins 50 connected respectively to the two ends of the metal conductive cable 40.

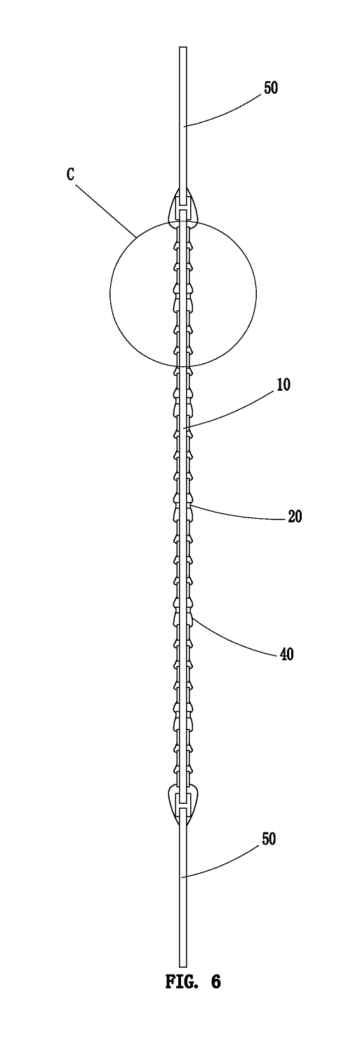

Referring to FIGS. 6-8, in this embodiment, to further increase illumination area and angle of the LED filament, two side surfaces of the substrate 10 are equipped with said light emitting unit 20.

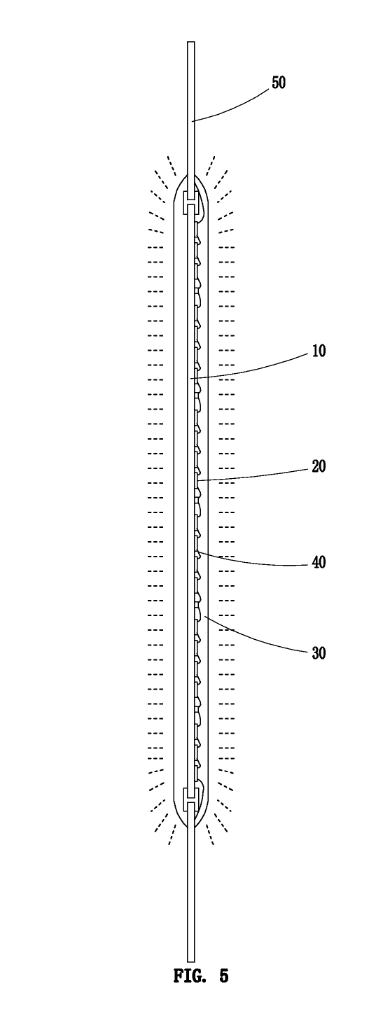

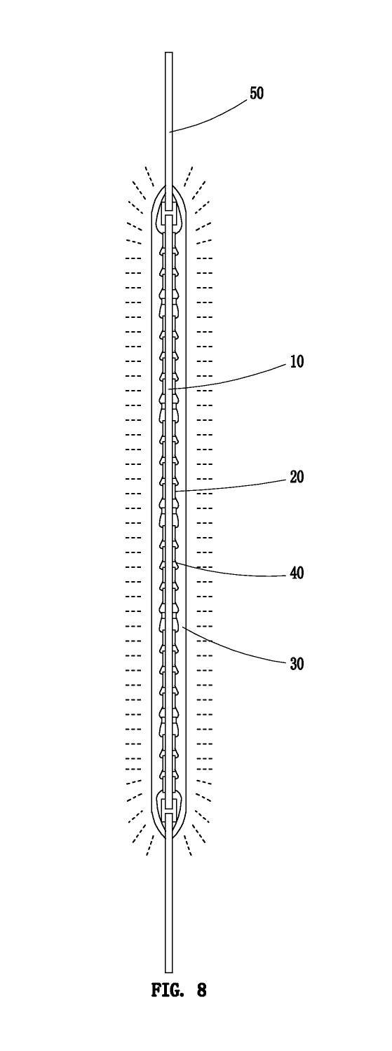

The substrate 10 of this embodiment may be formed by any existing substrate material. Referring to FIGS. 5 and 8, as a preferred embodiment, the substrate 10 is configured to be transparent so that light radiated from the light emitting unit 20 is able to pass through the substrate 10 and travels out from the other side surface, hence effectively enhancing illumination angle and efficiency of the LED filament, and realizing light radiation at 360 degree. In present embodiment, the substrate 10 is preferably made of transparent ceramic with unique optical characteristics. Further, owing to high temperature resistance, oxidization resistance, electrical insulation, and high voltage resistance of transparent ceramic material, the overall quality of the LED filament is sufficiently improved. Of course, other suitable material such as transparent plastic with high temperature resistant property may also be used to make the substrate 10.

When implementing the present invention, in case that only one side surface of the substrate 10 is provided with the light emitting unit 20, a single sided wafer bonding and wiring bonding packaging process operates. The detailed steps are explained below: wafer expanding—wafer bonding—baking—wiring bonding. In case both opposing side surfaces of the substrate 10 are provided with the light emitting unit 20, a double sided wafer bonding and wiring bonding packaging process applies. The detailed steps are explained below: wafer expanding—wafer bonding for a first side surface—baking the first side surface—wafer bonding for a second side surface—baking the second side surface—double side surface wiring bonding.

The package adhesive layer 30 is surrounded on the periphery of the light emitting unit 20 to form a protective film for the light emitting unit 20 and to form a second time optical lens for the light emitting unit 20, thereby increasing optical light reflection, reducing light loss, and improving optical efficiency.

In present embodiment, the package adhesive layer 30 is made from transparent colloid material containing fluorescent powder (hereinafter the “transparent colloid material containing fluorescent powder” is referred as to fluorescent colloid). Because yellow light will be generated when the fluorescent powder is excited by the blue light chips 21, and white light will be generated when the blue light emitted by the blue light chips 21 is blended with yellow light radiated by the fluorescent powder, the LED filament will generate light comparable to light generated by a traditional incandescent lamp filament. In addition, as the color rendering index of white light formed by cooperation of the blue light chips 21 and fluorescent powder is not high, it must be compensated by providing the red light chips 22 in order to obtain light with low color temperature yet high color rendering property. During implementing process, the number of the red light chips 22 is generally significantly less than the blue light chips 21. The number ratio between the blue light chips 21 and red light chips 22 may be determined based on desired optical efficiency. In this embodiment, one red light chip 22 is disposed between at least every two said blue light chips 21.

With reference to FIGS. 1, 5 and 8, in this embodiment, the package adhesive layer 30 completely enwraps the substrate 10 and light emitting unit 20 therein, and its cross section peripheral contour takes on circular shape with a diameter of 1.00 mm-10.00 mm. As an implementation, the package adhesive layer 30 may also have cross section peripheral contour of any other shape meeting required optical demands.

In this embodiment, the package adhesive layer 30 is formed by molding process. In other words, the package adhesive layer 30 is directly molded on the substrate 10 using molding machine and tool. The following steps are involved:

Placing a substrate 10 attached with a light emitting unit 20 into a mold cavity of a mold;

Clamping an upper mold and lower mold together and performing evacuating process; and

Injecting evenly mixed fluorescent colloid into the mold and performing curing process.

As the package adhesive layer 30 is fabricated by above molding process, the packaging process of the LED filament is more simple and accurate. Moreover, air-tightness of the molded package adhesive layer 30 is maintained effectively, thus greatly improving plastic packaging efficiency and yield, and reducing production cost as well.

During above molding process, to prevent deposition of the fluorescent powder inside the fluorescent colloid and maintain uniformity and concentration of the plastic molded product, more viscous fluorescent colloid may be created by adjustment such that no deposition of the fluorescent powder will occur for a certain period of time. Or, an anti-deposition device may be installed on the molding machine for continuously rotating the fluorescent colloid, thus making the fluorescent colloid active all the time. This avoids deposition of fluorescent powder inside the fluorescent colloid.

Based on this, the present invention also proposes a LED lamp incorporating the LED filament as described above and a glass casing covered on the periphery of the LED filament. The LED lamp in particular may be designed to be a bulb lamp, candle lamp and the like. The LED lamp can radiate light at 360 degree and color quality is effectively improved by placement of the LED filament into the glass casing.

Though various embodiments of the invention have been illustrated above, a person of ordinary skill in the art will understand that, variations and improvements made upon the illustrative embodiments fall within the scope of the invention, and the scope of the invention is only limited by the accompanying claims and their equivalents.

1. A LED filament comprising a substrate, a light emitting unit secured onto at least one side surface of the substrate, and a package adhesive layer surrounded on the periphery of the light emitting unit; the substrate being configured to be of an elongated bar construction; the light emitting unit comprising a plurality of blue light chips and red light chips regularly distributed on the substrate and sequentially connected to one another in series.

2. The LED filament as recited in claim 1, wherein one red light chip is disposed between at least every two said blue light chips.

3. The LED filament as recited in claim 1, wherein the substrate is 5.00 mm-200.00 mm long, 0.50-10.00 mm wide, and 0.10 mm-5.00 mm high.

4. The LED filament as recited in claim 1, wherein two side surfaces of the substrate are provided with the light emitting unit.

5. The LED filament as recited in claim 1, wherein the package adhesive layer is circular in cross section and has a diameter of 1.00 mm-10.00 mm.

6. The LED filament as recited in claim 1, wherein the package adhesive layer is made of transparent colloid material mixed with fluorescent powder.

7. The LED filament as recited in claim 1, wherein the substrate is configured to be transparent.

8. The LED filament as recited in claim 1, wherein the package adhesive layer is formed by molding process.

9. The LED filament as recited in claim 1, wherein the blue and red light chips are connected to one another in series by a metal conductive cable, and the two ends of the substrates are provided with electrode pins connected respectively to the two ends of the metal conductive cable.

10. A LED lamp comprising a LED filament, the LED filament comprising a substrate, a light emitting unit secured onto at least one side surface of the substrate, and a package adhesive layer surrounded on the periphery of the light emitting unit; the substrate being configured to be of an elongated bar construction; the light emitting unit comprising a plurality of blue light chips and red light chips regularly distributed on the substrate and sequentially connected to one another in series.

11. The LED lamp as recited in claim 10, wherein one red light chip is disposed between at least every two said blue light chips.

12. The LED lamp as recited in claim 10, wherein the substrate is 5.00 mm-200.00 mm long, 0.50-10.00 mm wide, and 0.10 mm-5.00 mm high.

13. The LED lamp as recited in claim 10, wherein two side surfaces of the substrate are provided with the light emitting unit.

14. The LED lamp as recited in claim 10, wherein the package adhesive layer is circular in cross section and has a diameter of 1.00 mm-10.00 mm.

15. The LED lamp as recited in claim 10, wherein the package adhesive layer is made of transparent colloid material mixed with fluorescent powder.

16. The LED lamp as recited in claim 10, wherein the substrate is configured to be transparent.

17. The LED lamp as recited in claim 10, wherein the package adhesive layer is formed by molding process.

18. The LED filament as recited in claim 10, wherein the blue and red light chips are connected to one another in series by a metal conductive cable, and the two ends of the substrates are provided with electrode pins connected respectively to the two ends of the metal conductive cable.
